(19) United States
(12) Patent Application Publication
(10) Pub. No.: US 2008/0011952 A1
(43) Pub. Date: Jan. 17, 2008

(54) Non-Dispersive Infrared Gas Analyzer

(75) Inventors: Walter Fabinski, Kriftel (DE); Carsten Rathke, Schoeneck (DE)

Correspondence Address: ABB INC.;LEGAL DEPARTMENT-4U6, 29801 EUCLID AVENUE, WICKLIFFE, OH, 44092, US

(73) Assignee: ABB PATENT GMBH, Ladenburg (DE)

(21) Appl. No.: 11/630,919

(22) PCT Filed: Jun. 9, 2005
(86) PCT No.: PCT/EP05/06194

§ 371 Date: Sep. 17, 2007

(30) Foreign Application Priority Data
Jun. 30, 2004 (DE) 10 2004 031 643.0

(51) Int. Cl. G01N 21/37

(52) U.S. Cl. 250/344

(57) ABSTRACT

The invention relates to a non-dispersive infrared gas analyzer (1) for identifying a test gas containing a number of gas constituents, comprising a radiation source (2), a modulating device (3), a measuring cell (4), which has a measuring chamber (4a) and a comparing chamber (4b), and comprising an optopneumatic detector unit (5) that has a first detector (5a), which, for measuring gas constituent A, is filled with gas constituent A, and has a second detector (5b), which is situated behind the first detector (5a) and which, for measuring gas constituent B, is filled with the isotope B* thereof.

The invention relates to a non-dispersive infrared gas analyzer for determining a measurement gas containing a plurality of gas components, comprising a radiation source, a modulation device, a measuring cuvette comprising a measuring chamber and a comparison chamber, and also comprising an optopneumatic detector unit.

Gas analysis with the aid of measuring instruments that operate according to the principle of non-dispersive infrared spectroscopy (NDIR) has been known for a long time. Areas of application are extensive and encompass, inter alia, flue gas analysis, process metrology in chemical process engineering and recently to an increased extent ambient air measurement and air conditioning and air quality regulation in buildings.

The basic construction of a gas analyzer is essentially always the same. The radiation emitted by a radiation source radiates through a measuring cuvette containing the gas to be measured and impinges on a detector. On the way through the measuring cuvette, the initial intensity emitted by the radiation source is attenuated by absorption processes. The Lambert-Beer law holds true for the relationship between the gas concentration to be determined and the intensity attenuation. The generation of a detector signal with a sufficient signal/noise ratio requires a modulation of the radiation emerging from the radiator. The gas to be measured passes into the measuring cuvette either by diffusion operation or with the aid of a pump. The detector detects the radiation decrease and converts the pressure surges occurring in the detector into an electrical signal. Since the absorption lines of the measurement component coincide with those of the detector filling gas, a high selectivity generally arises. Although other gases have an absorption spectrum which deviates from that of the measurement component, overlaps of the spectra can occur. In such cases, the cross-sensitivity that arises is a limiting factor.

In general, gas analyzers of this type require not only the measurement beam path but also a comparison beam path, in order to produce a higher zero point stability. For this purpose, the measuring cuvettes are embodied doubly—with a measuring chamber and a comparison chamber.

U.S. Pat. No. 5,163,332 describes an NDIR gas analyzer comprising a measuring cuvette which can be operated in the diffusion mode. In this case, the measuring cuvette comprises a closed tube having a plurality of discrete gas access openings distributed over the tube length. Gas exchange takes place via a membrane clamped in the gas access openings. The measurement construction is disadvantageously complicated by virtue of the membrane system.

Apparatuses of this type are often used in practice for measurement of large and small concentrations. One example, in combustion engineering, is the determination of small concentrations of CO and large concentrations of CO₂. Here the gas analyzer is configured by adaptation of different cuvette lengths. An optimum configuration is achieved for example by means of a short cuvette for the large concentration and a long cuvette for the small concentration. This requires two NDIR gas analyzers or two beam paths in one NDIR gas analyzer. However, this disadvantageously requires an increased outlay particularly for the hardware and for the calibration.

Furthermore, it is generally known that the desired linear relationship between concentration and output flow requires electronic measurements for linearization. Besides the pure absorption, it is necessary to ascertain an extinction along the radiation path through the measuring cuvette. Consequently, the measurement range is limited by a maximum product of cuvette length and concentration. In this case, the extinction is to be understood to mean the nonselective general attenuation of radiation by gases or solids. The extinction, too, effects an attenuation of the original signal and generally simulates an absorption within the NDIR gas analyzer. For this reason, the cuvette lengths cannot be chosen to be arbitrarily long.

The present invention is based on the object of providing a non-dispersive infrared gas analyzer for simultaneously measuring a plurality of components of a gas in which the abovementioned disadvantages are avoided, the gas analyzer being distinguished by a simple construction in conjunction with high sensitivity and accuracy.

According to the invention, this object is achieved by means of the features of claim 1. Further advantageous refinements of the invention are represented in the dependent claims.

The invention provides for the optopneumatic detector unit to have a first detector, which is filled with the gas component A for measurement of the gas component A. Arranged behind the first detector is a second detector, which, for measurement of the gas component B, is filled with its isotope B*. What is particularly advantageous in this case is that a single measuring cuvette is used in order to obtain the same dynamic profile for the different gas components. According to the invention, use is made of a plurality of detectors which are connected in series one behind another and which selectively measure the individual gas components. It must be taken into account in this case, however, that the possible gas components or the correspondingly selected absorption bands have to be selected in such a way that each detector has a maximum absorption for the gas component to be measured and is correspondingly transparent to the component which is to be detected in the subsequent detector. Since the series-connected detectors comprise small gas volumes, the extinctions that arise in the detectors are negligible. According to the present invention, the infrared gas analyzer has a long measuring cuvette tailored to the component having the small concentration. The optopneumatic first detector is filled with the gas component A having the smaller concentration in the measurement gas. The second detector (receiver) is situated behind the first detector (receiver). Said second detector is expediently filled with the stable isotope B* of the gas component B. It is generally known that the measurement gas comprises a mixture of the basic gas concentration and its isotopes. In this case, stable isotopes are also contained in the measurement gas. It is furthermore known that the concentration of the isotope of the gas component B is generally in a fixed ratio with respect to the concentration of the basic gas component. In other words, it can be established that the measurement gas is present with the natural isotope diversity. By way of example, natural CO₂ comprises approximately 98.9 percent of 12CO₂ and a proportion of approximately 1.1 percent of 13CO₂. The concentration of 13CO₂ with respect to 12CO₂ in air and in combustion gases of fossil fuels does not fluctuate more than 2 parts per thousand, so that the isotope ratio can be assumed to be sufficiently constant for most technical processes. Consequently, 13CO₂ can be measured instead of 12CO₂. According to the invention, the measurement of CO₂ by means of the 13CO₂ concentration is determined with a cuvette 100 times longer than for the basic gas component. If the composition of CO₂ changes, then the largely constant small proportion of 13CO₂ also changes proportionally in representative fashion. It must be taken into account, however, that the concentration present in this case is approximately 100 times smaller than when CO₂ overall or 12CO₂ is measured. Consequently, the absorption in the measuring cuvette is in turn so small that a greatest possible light residual signal passes to the detector unit. Consequently, it is possible for the representative measurement of 13CO₂ as representative of CO₂ generally also to be applied to other molecules, such as, for example, to CO or CH₄ and others. In the case of a measurement gas comprising the gas components A and B, according to the invention the first detector measures A directly, that is to say not isotope-selectively, for example owing to the smaller proportion. The second detector, which is connected behind the first detector and is filled with the isotope B*, measures the isotope with respect to B as representative of the B concentration. It must be taken into account here that the first detector is configured such that it is transparent to the greatest possible extent with respect to the B* band in this frequency range. For this reason, the absorption band of A must not coincide with that of B*.

In this case, the radiator may be formed as an infrared radiator whose radiation is modeled by the modulation device and, after radiating through the measuring instruments filled with the measurement gas to be analyzed, enters the first detector through the radiation-transmissive window. The radiation penetrates through the first detector and leaves the latter through a further radiation-transmissive window and enters into the second detector through a further radiation-transmissive window.

In one preferred embodiment of the invention, the first and/or the second detector may be formed as two-layer detector. In this case, the two-layer detector preferably comprises a measuring detector chamber and a comparison detector chamber arranged one behind another in the radiation direction. Preferably, an electrical signal is generated between said chambers capacitively according to the optopneumatic effect. The first, front chamber, into which the radiation signal coming from the measuring cuvette enters, is the actual measuring detector chamber. The second chamber arranged behind it is preferably optically passive, that is to say that the radiation signal does not penetrate into a second chamber. The second chamber is preferably merely pneumatically connected to the first chamber via a membrane capacitor, but is optically isolated from the first chamber.

In order to suppress the cross-sensitivity from the gas component B to B*, a filter apparatus may be connected in the beam path upstream of the detector unit—in particular upstream of the second detector filled with the isotope B*. The filter apparatus is preferably arranged between the measuring cuvette and the detector unit. In one preferred embodiment, the filter apparatus has a filter cuvette filled with the gas component B. Said filter cuvette filled with the gas component B damps the dominant B main bands to an extent such that it is possible to work with the downstream B detector in a flatter and hence more favorable region of the characteristic curve. In a further alternative of the invention, the filter cuvette may be formed integrally with the measuring cuvette. No filtering is required between the first and second detectors in the case of the present invention.

A calibration apparatus can advantageously be arranged between the measuring cuvette and the detector unit. In this case, the calibration apparatus may comprise a calibration cuvette filled with a gas mixture composed of A and B*. The calibration cuvette may advantageously be pivoted into the beam path between the measuring cuvette and the first detector.

In a further possible embodiment, an optopneumatic detector unit is provided in which the first and second detectors are interchanged.

According to the invention, the modulation device interrupts the radiation of the radiation source in antiphase. The modulation device arranged between radiation source and measuring cuvette may be formed as a chopper disk. The chopper disk interrupts the incident radiation periodically in antiphase, so that radiation alternately passes into the measuring chamber and into the comparison chamber of the measuring cuvette. Residual light or scattered light is eliminated with the aid of a chopper disk, so that only the light of the radiation source which is chopped at a fixed frequency is a basis for the electronic evaluation of the signal.

The measuring cuvette expediently has an inner wall area formed with a metal layer. The metal layer may have a specific proportion of aluminum, by way of example. What is thereby achieved is that a high reflection is achieved within the measuring cuvette and the cross-sensitivity of the gas analyzer toward water vapor is simultaneously reduced.

Further advantages, features and details of the invention emerge from the description below, which describes exemplary embodiments of the invention in detail with reference to the drawings. In this case, the features mentioned in the claims and in the description may be essential to the invention in each case individually by themselves or in any desired combination. In the figures:

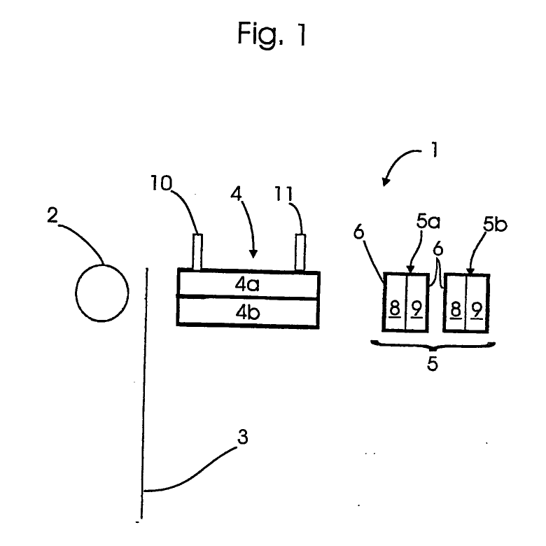

FIG. 1 shows a schematic illustration of a non-dispersive infrared gas analyzer according to the invention, and

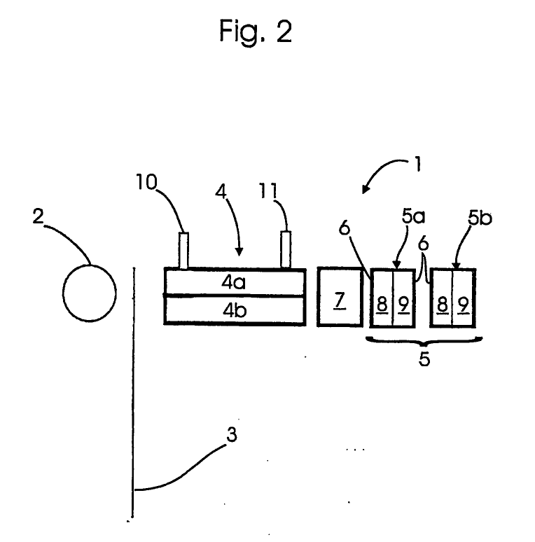

FIG. 2 shows a non-dispersive infrared gas analyzer in accordance with FIG. 1 with a filter apparatus arranged between the measuring cuvette and the optopneumatic detector unit.

FIG. 1 illustrates a non-dispersive infrared gas analyzer 1 having an infrared radiation source 2 for generating a broadband infrared radiation. The gas analyzer 1 comprises a measuring cuvette 4, through which the measurement gas to be analyzed flows through an input 10 and an output 11, said measurement gas containing a plurality of components whose proportions are intended to be determined. The measuring cuvette 4 is irradiated by the radiation source 2, the infrared radiation being “chopped” by a modulation device 3. In this case, the modulation device 3 is formed as a chopper disk 3, which may be driven for example by a motor (not illustrated). The light emerging from the measuring cuvette 4 passes into an optopneumatic detector unit 5 comprising a first detector 5a and a second detector 5b arranged behind the first detector 5a. In the exemplary embodiment illustrated, the first and the second detector 5a, 5b is formed as a two-layer detector. The two-layer detector 5a, 5b in each case comprises a measuring detector chamber 8 and a comparison detector chamber 9. In this case, the comparison detector chamber 9 and the measuring detector chamber 8 are pneumatically connected to one another. The pressure differences—detected by a flow sensor—in the detector chambers 8, 9 of the first and second detectors 5a, 5b are amplified by an amplifier (not illustrated) and fed into an evaluation unit (not shown) which passes the measurement results to diverse output instruments.

The measuring cuvette 4 has a measuring chamber 4a and a comparison chamber 4b, through which the infrared radiation passes. Furthermore, the first and second detectors 5a, 5b have windows 6 which are radiation-transmissive transversely with respect to the radiation direction.

The first optopneumatic detector 5a arranged behind the measuring cuvette 4 is filled with the gas component A, and measures the latter directly. The second detector 5b connected behind the first detector, for measurement of the gas component B, is filled with its isotope B*. In this case, the gas component A has the significantly smaller proportion than the gas component B in the contained measurement gas. The second detector 5b thus measures the concentration of B* as representative of the gas component B and deduces the concentration of B. In order that satisfactory results can be obtained, the first detector 5a is optically transparent with regard to the gas component B* to be measured or the characteristic absorption bands thereof. It goes without saying that further detectors may be provided for further gas components, which are then simply lined up behind the other two detectors 5a, 5b (not illustrated).

FIG. 2 shows a non-dispersive infrared gas analyzer 1 in accordance with FIG. 1, a filter apparatus 7 being arranged between the measuring cuvette 4 and the optopneumatic detector unit 5. The filter apparatus 7 is formed as a filter cuvette filled with the gas component B. In a further embodiment (not illustrated), the filter cuvette 7 may be formed integrally with the measuring cuvette 4. The cross-sensitivity of the gas B to B* is suppressed, in particular, by virtue of the arrangement of the filter cuvette 7.

### LIST OF REFERENCE SYMBOLS

1 Non-dispersive infrared gas analyzer
2 Radiation source
3 Modulation device, chopper disk
4 Measuring cuvette
4a Measuring chamber of the measuring cuvette
4b Comparison chamber of the measuring cuvette
5 Detector unit
5a First detector
5b Second detector
6 Window
7 Filter apparatus
8 Measuring detector chamber
9 Comparison detector chamber
10 Input
11 Output

1. A non-dispersive infrared gas analyzer (1) for determining a measurement gas containing a plurality of gas components, comprising a radiation source (2), a modulation device (3), a measuring cuvette (4) comprising a measuring chamber (4a) and a comparison chamber (4b) and an optopneumatic detector unit (5) having a first detector (5a), which is filled with the gas component A for measurement of the gas component A, and a second detector (5b), which is arranged behind the first detector (5a) and which, for measurement of the gas component B, is filled with its isotope B*.

2. The non-dispersive infrared gas analyzer (1) as claimed in claim 1, characterized in that the first and second detectors (5a, 5b) have windows (6) that are radiation-transmissive transversely with respect to the radiation direction.

3. The non-dispersive infrared gas analyzer (1) as claimed in claim 1 or 2, characterized in that the first and/or the second detector (5a, 5b) are/is formed as two-layer detector.

4. The non-dispersive infrared gas analyzer (1) as claimed in one of the preceding claims, characterized in that a calibration apparatus can be arranged between the measuring cuvette (4) and the detector unit (5).

5. The non-dispersive infrared gas analyzer (1) as claimed in claim 4, characterized in that the calibration apparatus comprises a calibration cuvette filled with a gas mixture composed of A and B*.

6. The non-dispersive infrared gas analyzer (1) as claimed in one of the preceding claims, characterized in that the first and second detectors (5a, 5b) are interchangeable.

7. The non-dispersive infrared gas analyzer (1) as claimed in one of the preceding claims, characterized in that the modulation device (3) interrupts the radiation of the radiation source (2) in antiphase.

8. The non-dispersive infrared gas analyzer (1) as claimed in one of the preceding claims, characterized in that the modulation device (3) has a chopper disk.

9. The non-dispersive infrared gas analyzer (1) as claimed in one of the preceding claims, characterized in that a filter apparatus (7) can be arranged between the measuring cuvette (4) and the detector unit (5).

10. The non-dispersive infrared gas analyzer (1) as claimed in claim 9, characterized in that the filter apparatus (7) comprises a filter cuvette (7) filled with the gas component B.

11. The non-dispersive infrared gas analyzer (1) as claimed in claim 10, characterized in that the filter cuvette (7) is formed integrally with the measuring cuvette (4).

12. The non-dispersive infrared gas analyzer (1) as claimed in one of the preceding claims, characterized in that the two-layer detector (5a, 5b) comprises a measuring detector chamber (8) and a comparison detector chamber (9) arranged one behind another in the radiation direction.

13. The non-dispersive infrared gas analyzer (1) as claimed in claim 12, characterized in that the comparison detector chamber (9) and the measuring detector chamber (8) are pneumatically connected to one another.

14. The non-dispersive infrared gas analyzer (1) as claimed in one of the preceding claims, characterized in that the measuring cuvette (4) has an inner wall area formed with a metal layer.
